(19) United States
(12) Patent Application Publication
(10) Pub. No.: US 2025/0390815 A1
(43) Pub. Date: Dec. 25, 2025

(54) TASK DETERMINATION USING GENERATIVE AI

(71) Applicant: SAP SE, Walldorf (DE)

(72) Inventors: Jens SCHYMA, Forst (DE); Joachim SCHNEIDER, Heidelberg (DE)

(21) Appl. No.: 18/883,018

(22) Filed: Sep. 12, 2024

Related U.S. Application Data
(60) Provisional application No. 63/663,262, filed on Jun. 24, 2024.

(51) Int. Cl. G06Q 10/0631

(52) U.S. Cl. CPC G06Q 10/06313

(57) ABSTRACT

Systems and methods include reception of a description of a project, instruction of a text generation model to generate text describing a plurality of tasks based on the description, determination of a hierarchical structure of the plurality of tasks from the generated text, and generation of a project plan file including the hierarchical structure and the plurality of tasks.

### CROSS-REFERENCE TO RELATED APPLICATIONS

This application claims priority to and the benefit of U.S. Provisional Patent Application Ser. No. 63/663,262, filed Jun. 24, 2024, the entire contents of which are incorporated herein in for all purposes.

### BACKGROUND

Project planning applications provide tracking and management of complex projects consisting of many interdependent tasks. A project manager may operate a project planning application to efficiently deploy supplies, workers and equipment to suitable locations at suitable times. A project planning application also facilitates on-the-fly alterations to a project plan due to delays or other events.

Development of a project plan requires a significant amount of time and learned proficiency with a project planning application. For example, a project plan may include several data structures, such as a schedule, a scope structure, a cost breakdown, a risk breakdown and a resource breakdown. Moreover, these data structures must be regularly updated in a consistent manner during the course of a project to reflect shifting circumstances.

Project plan templates may be used to assist in the creation of a project plan. Use of a template in this manner typically requires extensive adjustments to the template. These adjustments can be effort-intensive as many individual elements of the underlying data structures require moving, deletion and/or addition.

Project planning systems are desired which require less time, skill, and/or domain knowledge than current systems.

### BRIEF DESCRIPTION OF THE DRAWINGS

FIG. 1 is a block diagram of an architecture to generate project plans using a text generation model according to some embodiments.

FIG. 2 comprises a flow diagram of a process to generate a project plan using a text generation model according to some embodiments.

FIG. 3 is a user interface for inputting a description of a project plan according to some embodiments.

FIG. 4 is a user interface for selecting a project plan template according to some embodiments.

FIG. 5 is a user interface presenting tasks of a generated project plan according to some embodiments.

FIG. 6 is a user interface for describing updates to a project plan according to some embodiments.

FIG. 7 is a user interface presenting tasks of an updated project plan according to some embodiments.

FIG. 8 comprises a flow diagram of a process to generate a project plan using a text generation model according to some embodiments.

FIG. 9 is a block diagram of a hardware environment to project plans using a text generation model according to some embodiments.

### DETAILED DESCRIPTION

The following description is provided to enable any person in the art to make and use the described embodiments and sets forth the best mode contemplated for carrying out some embodiments. Various modifications, however, will be readily-apparent to those in the art.

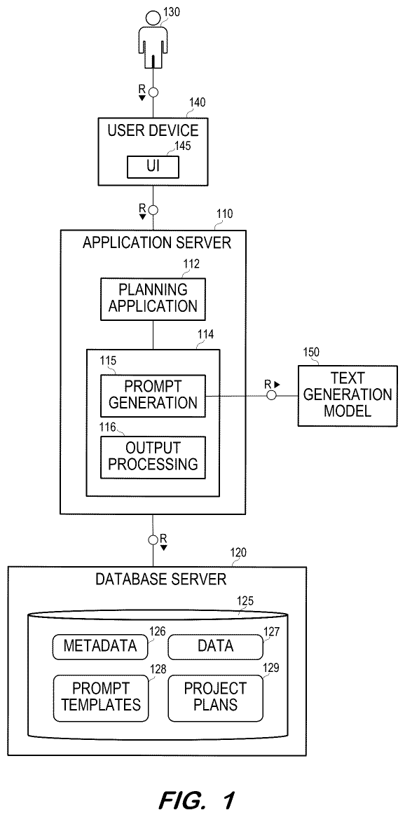

FIG. 1 is a block diagram of an architecture to generate project plans using a text generation model according to some embodiments. Each of the illustrated components may be implemented using any suitable combination of local, on-premise, cloud-based, distributed (e.g., including distributed storage and/or compute nodes) computing hardware and/or software that is or becomes known. Each component described herein may be executed by one or more physical and/or virtualized servers. For example, server 110 and/or server 120 may comprise one or more servers, virtual machines, clusters of a container orchestration system and any other application execution environment that is or becomes known.

Two or more components of FIG. 1 may be co-located. In some embodiments, two or more components are implemented by a single computing device. One or more components may be implemented by a cloud service (e.g., Software-as-a-Service, Platform-as-a-Service) owned and managed by one or more different entities as is known in the art. A cloud-based implementation of any components of FIG. 1 may apportion computing resources elastically according to demand, need, price, and/or any other metric.

Application server 110 may provide an operating system, services, I/O, storage, libraries, frameworks, etc. to applications executing therein. Planning application 112 may comprise program code executable by at least one processing unit of application server 110 to provide the functions described herein based on coded logic and data. Planning application 112 may provide any other computing functions that are or become known.

Planning application 112 may access generative artificial intelligence (i.e., GenAI) services 114 during operation as described herein. Services 114 comprise prompt generation service 115 and output processing service 116. Although depicted separately, planning application 112 may include one or both of services 114 in some embodiments.

Prompt generation service 115 creates prompts for transmission to a text generation model. As is known in the art, a prompt includes instructions to a text generation model which describe a text output desired from the text generation model. The prompts may instruct a text generation model to generate text describing a plurality of tasks of a project plan. Prompt generation service 115 may create prompts based on user input received from planning application 112, existing prompt templates, and/or stored project plans.

Output processing service 116 receives text generated by a text generation model. Service 116 may determine a hierarchical structure of the plurality of tasks described by the received text. Service 116 may also or alternatively calculate a schedule for the plurality of tasks based on the received text. Output processing service 116 may also generate a project plan based on the hierarchical structure, the plurality of tasks and the schedule. In some embodiments, service 116 includes a sandbox for execution of scripts included in the received text to generate task descriptions.

Applications 112 and services 114 may access database 125 of database server 120 during operation. Database 125 may provide a database management system (not shown) for communication therewith and management thereof as is known in the art. Database 125 may be implemented using one or more storage systems, each of which may be standalone or distributed, on-premise or cloud-based. Database 125 may comprise any type of database, data warehouse, object store, or other storage system that is or becomes known.

Database 125 stores metadata 126 which describes the structure and interrelationships (i.e., the schema) of data 126. Data 127 may comprise tabular data stored in a columnar or row-based format, object data or any other type of data that is or becomes known. Metadata 126 and data 127 may be stored by application server 110 in some embodiments.

Each of prompt templates 128 may comprise text instructions intended for a text generation model. A prompt template 128 may be considered a “system prompt” to be populated or otherwise accompanied by text of a “user prompt”. Prompt templates 128 may comprise templates for instructing a model to, for example, generate a text description of tasks of a project based on a description of the project, update a text description of tasks of a project based on a description of the updates, select a text description of tasks from a set of descriptions based on a description of a project, or select from among several text descriptions of tasks of a given project based on a description of the project. One or more of prompt templates 128 may describe a desired format of a text description of tasks of a project from which a hierarchical structure of the tasks may be derived. One or more of prompt templates 128 may instruct a model to generate scripts executable to generate text descriptions of tasks of a project.

Each of project plans 129 may comprise a file describing a hierarchical structure of a plurality of tasks of a project, in a manner suitable for display and manipulation by a planning application such as planning application 112. According to some embodiments, a project plan 129 may be associated with a user-inputted text description which resulted in the project plan 129, and/or text generated by a model based on the user-inputted text and which was used to generate the project plan 129.

Database 125 may also store model-generated summaries of prior project plan generation. The summaries may be based on a description of a project, text generated by a model based on the description, a project plan created based on the model-generated text, text describing an update to the project plan, and second text generated by a model based on the text describing the update to the project plan. Such summaries, as well as prompt templates 128 and project plans 129, may be stored in data 127.

Planning application 112 may comprise a multi-tenant application, but embodiments are not limited thereto. Multi-tenancy facilitates the sharing of computing resources (e.g., processor cycles, memory) among disparate groups of users. For example, a single multi-tenant application may serve requests received from several independent tenants (e.g., customers) each consisting of multiple end users. Such an application may use a much smaller computing resource footprint than would be required to provision one application per tenant.

Database 125 may be multi-tenant aware, serving requests based on the tenant associated with the request. If database 125 is not multi-tenant aware, one schema of a single instance may be used for all tenants, where the data of each tenant is partitioned via a discriminating column. In this case, application 112 is responsible for tracking and managing the data in a tenant-aware manner, for example by using the values of the discriminating column to identify the data belonging to specific tenants.

User 130 may operate user device 140 to interact with planning application 112. User device 140 may comprise but is not limited to a laptop computer, a desktop computer, a smartphone, and a tablet computer. User device 140 includes one or more processing units to execute program code of UI 145.

UI 145 may comprise a Web browser or another application providing user interfaces for interacting with planning application 112. UI 145 may comprise a front-end UI application corresponding to planning application 112 which executes within a virtual machine of a Web browser to communicate with planning application 112 and present user interfaces thereof. User 130 may interact with such a user interface using a keyboard and/or pointing device of user device 140.

Text generation model 150 may comprise a neural network trained to generate text based on input text. Text generation model 150 may be implemented by, for example, executable program code, a set of hyperparameters defining a model structure and a set of corresponding weights, or any other representation of an input-to-output mapping which was learned as a result of the training. According to some embodiments, model 150 is an LLM conforming to a transformer architecture. A transformer architecture may include, for example, embedding layers, feedforward layers, recurrent layers, and attention layers. Generally, each layer includes nodes which receive input, change internal state according to that input, and produce output depending on the input and internal state. The output of certain nodes is connected to the input of other nodes to form a directed and weighted graph. The weights as well as the functions that compute the internal states are iteratively modified during training.

An embedding layer creates embeddings from input text, intended to capture the semantic and syntactic meaning of the input text. A feedforward layer is composed of multiple fully-connected layers that transform the embeddings. Some feedforward layers are designed to generate representations of the intent of the text input. A recurrent layer interprets the tokens (e.g., words) of the input text in sequence to capture the relationships between the tokens. Attention layers may employ self-attention mechanisms which are capable of considering different parts of input text and/or the entire context of the input text to generate output text.

Non-exhaustive examples of trained text generation model 150 include GPT-4, LaMDA, Claude or the like. Model 150 may be publicly available or deployed within a landscape which is trusted by a provider of application server 110. Similarly, text generation model 150 may be trained based on public and/or private data.

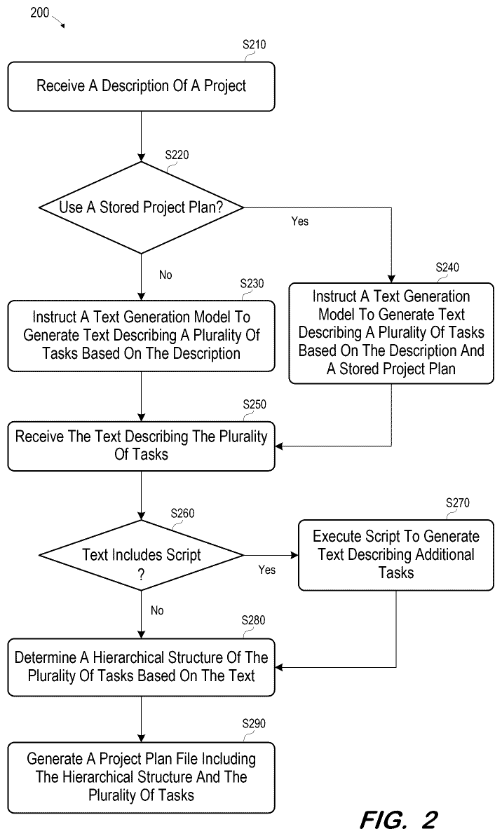

FIG. 2 comprises a flow diagram of process 200 to generate a project plan using a text generation model according to some embodiments. Process 200 and the other processes described herein may be performed using any suitable combination of hardware and software. Program code embodying these processes may be stored by any non-transitory tangible medium, including a fixed disk, a volatile or non-volatile random-access memory, a DVD, a Flash drive, or a magnetic tape, and executed by any one or more processing units, including but not limited to a processor, a processor core, and a processor thread. Embodiments are not limited to the examples described below.

A description of a project is received at S210. The description may be created in any suitable manner. A user may, for example, input the description into an application UI via text, speech-to-text, etc.

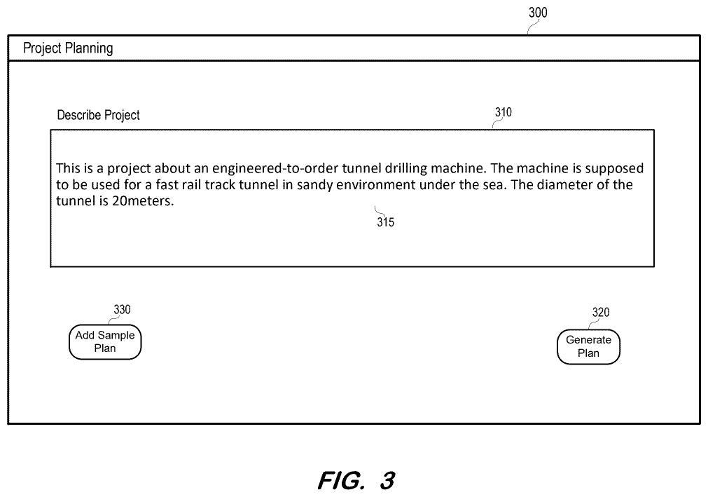

FIG. 3 illustrates user interface 300 of an application according to some embodiments. Embodiments are not limited to the contents or layout of user interface 300. In one example, user device 140 executes a Web browser to access planning application 112 via HTTP and to receive user interface 300 in return.

User interface 300 includes field 310 for inputting a description of a project. Example description 315 relates to a tunnel drilling machine and the following description will reference this example. Selection of Generate Plan control 320 causes the description to be received at S210.

Next, at S220, it is determined whether a stored project plan is to be used to assist generation of the project plan. It will initially be assumed that Generate Plan control 320 has been selected without an instruction to use a stored project plan, causing flow to proceed to S230.

At S230, a text generation model is instructed to generate text describing a plurality of tasks based on the received description. S230 may comprise generation of a prompt including the description and instructing a model to generate text describing a plurality of tasks based on the received description. The prompt may be generated based on a prompt template such as one of prompt templates 128 of database 125.

According to one example, the following prompt template is used at S230:
[Begin System Prompt]
You are an intelligent project management assistant and you support the project manager in working on the project schedule.
Your task is to create a new project plan.
Your responses are processed by a project management software and therefore must be strictly containing the entire project plan in csv format with the following columns:
id; parent_id; name; duration; start_date; predecessor_ids
The fields have to be separated by a semicolon!
IDs are integers starting at 0.
There can be only one element at the top without a parent (then set to null) and its ID must be ‘0’.
All other elements must have a parent.
The unit of duration is days and must be an integer greater than 0.
Every element must have a start_date in the format ‘yyyy-MM-dd’.
In the predecessor field, list all ids of the elements that are predecessors for this project element from a scheduling point of view.
!!! It is important that you only return a project plan with no extra text!!!
You will receive a description of the project.
From the description you must derive a meaningful project plan.
Respond always with the full project plan in the CSV format as defined.
[End System Prompt]

The above example system prompt advantageously instructs the model to return text describing the tasks in a format (i.e., id; parent_id; name; duration; start_date; predecessor_ids) from which a hierarchical structure of the tasks may be determined. A corresponding user prompt may be as follows:
[Begin User Prompt]
The description of the project is:
<populate with received description>
[End User Prompt]

To instruct a model at S230, prompt generation service 115 may retrieve the above system prompt and user prompt from prompt templates 128, populate the user prompt with the text received at S210, and send the system prompt and user prompt to model 150.

Returning to S220, some embodiments allow a user to specify that a stored project plan should be provided to a text generation model along with the received description. For example, prior to selecting Generate Plan control 320, user 130 may select Add Sample Plan control 330 of user interface 300. The user subsequently selects Generate Plan control 320 and flow proceeds from S220 to S240. At S240, a text generation model is instructed to generate text describing a plurality of tasks based on the received description and on a stored project plan. S240 may comprise generating a prompt to instruct a text generation model to select a stored project plan based on the received description, and then generating a second prompt to instruct the model to generate text describing a plurality of tasks. As mentioned above, project plans 129 may be stored in association with respective descriptions and model-generated text from which the plans were generated. Accordingly, the second prompt may include a description and model-generated text stored in association with the selected project plan.

The prompts generated at S240 may be based on prompt templates 128 which are different from the prompt template 128 used at S230. According to one example, the following prompt template may be used to select a stored project plan at S240 (the italicized portions are not part of the template but are inserted at S240 by prompt generator 115 based on stored project plan descriptions, for example):
[Begin System Prompt]
Your task is to choose a project plan according to a project description.
You are supposed to only return an integer number.
You will receive a list of project plan descriptions that are assigned to integer numbers.
You will also receive a specific project description for a specific project.
This specific project description will resemble one or more from the list.
Choose the plan from the list that matches best.
These are the plans to choose from:
0=This is a plan for a typical implementation.
Adjustments in schedules and project elements need to be made according to the size and complexity of the system to be implemented.
1=This plan is for very large buildings such as skyscrapers or apartment buildings with more than 10 stories.
A few adjustments are necessary according to the customer's needs.
E.g.: The height of a building affects its weight which makes a stronger foundation necessary.
2=This plan is for cathedral and church buildings.
Traditionally, buildings like this are more complex in building techniques and have to be planned and calculated accordingly.
That makes for a slightly longer architectural planning and design phase.
3=This plan is for apartment buildings with a maximum of 10 stories.
A few adjustments are necessary according to the customer's needs.

4=This plan is for engineering to order project on the tunnel drilling machine. The user must specify the diameter of the tunnel and the environment in which the machine shall be applied.
Choose a plan according to the project description and return the assigned index.
[End System Prompt]

A corresponding user prompt for use at S240 is as follows, again with inserted text in italics:
[Begin User Prompt]
Specific project information:
This is a project about an engineered to order tunnel drilling machine. The machine is supposed to be used for a fast rail track tunnel in sandy environment under the sea. The diameter of the tunnel is 20 meters.
[End User Prompt]

Based on the above prompts, text generation model 150 may return the response “4”. Accordingly, a second set of system and user prompts may be created at S240 which are similar to the prompts described with respect to S230, but which also includes model-generated text associated with the selected project plan. Appendix A sets forth such a second set of system and user prompts according to some embodiments.

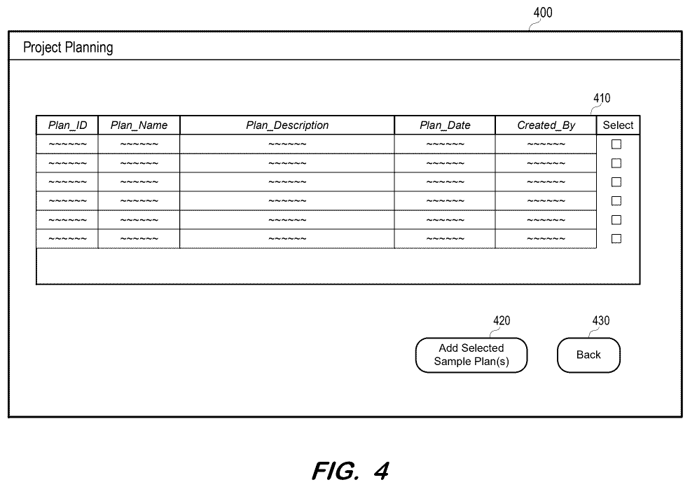

According to some embodiments, S220 may allow user selection of a stored project plan. For example, user selection of Add Sample Plan control 330 may result in display of interface 400 of FIG. 4. Interface 400 includes table 410 listing metadata of stored project plans, such as project plans 129 of database 125. The Plan_Description field of each plan may comprise a user-input description (e.g., description 315) which resulted in generation of the corresponding plan. User 130 may select one or more of the listed plans using the checkboxes of table 410. User 130 may then select control 420 to incorporate the selected one or more plans into the instruction of S240 or Back control 430 to return to interface 300 without selecting any plans.

If one or more plans are selected by a user as described above, S240 may proceed without instructing a text generation model to select a particular project plan. Rather, only the above-described second set of system prompt and user prompt are created and sent to the model, with the user prompt being populated with the text of the selected one or more project plans.

Flow proceeds to S250 after instructing the text generation model at S230 or instructing the at S240 as described above. In either case, text describing a plurality of tasks is received from the text generation model at S250. One example of received text is as follows:
0;;Engineered to Order Tunnel Drilling;;
1;0;Engineering Phase;60;2023-01-01
2;0;Manufacturing Phase;120;2023-07-01
3;20;Rocky Module Design;10;2023-07-01
4;20;Rocky Module Prototyping;10;2023-07-11
5;20;Rocky Module Testing;10;2023-07-21
6;21;Sandy Module Design;10;2023-07-01
7;21;Sandy Module Prototyping;10;2023-07-11
8;21;Sandy Module Testing;10;2023-07-21
9;22;Underwater Module Design;10;2023-07-01
10;22; Underwater Module Prototyping;10;2023-07-11
11;22; Underwater Module Testing;10;2023-07-21
12;23;Street Module Design;10;2023-07-01
13;23;Street Module Prototyping;10;2023-07-11
14;23;Street Module Testing;10;2023-07-21
15;24;Rail Module Design;10;2023-07-01
16;24;Rail Module Prototyping;10;2023-07-11
17;24;Rail Module Testing;10;2023-07-21
18;0;Final Assembly and Testing;30;2023-12-01
19;0;Project Closure;10;2024-01-01
20;0;Rocky Drilling Module;30;2023-07-01
21;0;Sandy Drilling Module;30;2023-07-01
22;0; Underwater Drilling Module;30;2023-07-01
23;0;Street Building Module;30;2023-07-01
24;0;Rail Building Module;30;2023-07-01

At S260, it is determined whether the received text includes one or more executable code scripts. The received text may include a script depending on whether the prompts used to prompt the text generation model included instructions for generating a script. For example, a text generation model may generate text such as “repeat as above” or similar, rather than output duplicate strings of text. However, a described project may include many repeated tasks (e.g., the same tasks for each floor of a building) and those repeated tasks must be specifically spelled out to properly generate a project plan therefrom. To address this need, a system prompt used at S230 may include instructions for generating a script in addition to text describing a plurality of tasks. Appendix B includes an example of such a system prompt according to some embodiments.

Accordingly, S260 may include determining whether the value of RepetitionLogicInCSV in the received text is true or false. If true, flow proceeds to S270 to execute any scripts included in the received texts. Execution of a script at S270 may add to the tasks already present in the text received at S250.

In one example, it is assumed that the following text is received from a text generation model at S250:

```
RepetitionLogicInCSV:true
EntireProjectPlanCSV:
id;parent_id;name;duration;start_date;predecessor_ids
0;null;Skyscraper Construction;600;2023-01-01;
1;0;Hotel Lobby Floor 1;30;2023-01-01;
1_1;1;Floor 1 - Steel Work;10;2023-01-01;
1_2;1;Floor 1 - Electrical Work;10;2023-01-01;1_1
1_3;1;Floor 1 - Plumbing; 10;2023-01-01;1_2
1_4;1;Floor 1 - Flooring;5;2023-01-01;1_3
1_5;1;Floor 1 - Wall Painting;5;2023-01-01;1_4
1_6;1;Floor 1 - Lobby Specific Tasks;10;2023-01-01;1_5
...{
for(i=2;i<=60;i++){
  var floorId = i;
  var parentId = 0;
  var namePrefix = “Hotel Floor “ + i;
  var duration = 25;
  var start = i === 2 ? “2023-01-01” : “2023-01-” + (i < 32 ? (“0” + i).slice(−2) : i − 31);
  var predecessor = i === 2 ? “1” : (i − 1);
  var elements = [ ];
  elements.push({id:floorId, parentId:parentId, name:namePrefix, duration:duration,
start_date:start, predecessor_ids:predecessor});
  for(subelemname of [“Steel Work”,“Electrical Work”, “Plumbing”,“Flooring”,“Wall
Painting”,“Furniture Installation”]){
    var newsubelement = {id:floorId+“_”+subelemname.replace(/ /g, “”),
parentId:floorId, name:namePrefix + “ − ” + subelemname, duration:5, relativestart:0,
predecessor_ids:“”};
    elements.push(newsubelement);
  }
}
}
...{
for(i=61;i<=110;i++){
  var floorId = i;
  var parentId = 0;
  var namePrefix = “Residential Floor ” + i;
  var duration = 20;
  var start = “2023-02-” + ((i − 60) < 29 ? (“0” + (i − 60)).slice(−2) : (i − 60 − 28));
  var predecessor = (i − 1);
  var elements = [ ];
  elements.push({id:floorId, parentId:parentId, name:namePrefix, duration:duration,
start_date:start, predecessor_ids:predecessor});
  for(subelemname of [“Steel Work”,“Electrical Work”,“Plumbing”]){
    var newsubelement = {id:floorId+“_”+subelemname.replace(/ /g, “”),
parentId:floorId, name:namePrefix + “ − ” + subelemname, duration:5, relativestart:0,
predecessor_ids:“”};
    elements.push(newsubelement);
  }
}
}
...{
for(i=111;i<=118;i++){
  var floorId = i;
  var parentId = 0;
  var namePrefix = “Restaurant Floor ” + i;
  var duration = 28;
  var start = “2023-04-” + ((i − 110) < 22 ? (“0” + (i − 110)).slice(−2) : (i − 110 − 21));
  var predecessor = (i − 1);
  var elements = [ ];
  elements.push({id:floorId, parentId:parentId, name:namePrefix, duration:duration,
start_date:start, predecessor_ids:predecessor});
  for(subelemname of [“Steel Work”,“Electrical Work”, “Plumbing”,“Flooring”, “Wall
Painting”,“Restaurant Specific Tasks”]){
    var newsubelement = {id:floorId+“_”+subelemname.replace(//g, “”),
parentId:floorId, name:namePrefix + “ − ” + subelemname, duration:5, relativestart:0,
predecessor_ids:“”};
    elements.push(newsubelement);
  }
}
}
119;0;Technical Floor 119;15;2023-04-28;118
119_1;119;Floor 119 - Steel Work;5;2023-04-28;
119_2;119;Floor 119 - Electrical Work;5;2023-04-28;119_1
119_3;119;Floor 119 - Plumbing;5;2023-04-28;119_2
120;0;Technical Floor 120;15;2023-04-29;119
120_1;120;Floor 120 - Steel Work;5;2023-04-29;
120_2;120;Floor 120 - Electrical Work;5;2023-04-29;120_1
120_3;120;Floor 120 - Plumbing;5;2023-04-29;120_2
ENDOFCSV
```

The received text above includes descriptions of tasks associated with floors 0, 1, 119 and 120 of a skyscraper project. The received text also includes three scripts, a first script for floors 2-60, a second script for floors 61-110, and a third script for floors 111-118. Due to the text “RepetitionLogicInCSV:true”, flow proceeds to S270 for execution of the three scripts. The execution results in text describing tasks for floors 2-60, for floors 61-110, and for floors 111-118.

Execution of a script may result in errors. Accordingly, S270 may comprise detecting such errors and instructing the text generation model to generate new text. The instruction may use a prompt template populated with the original description, the response received at S250 and the error. A maximum number of retries (e.g., three) may be specified, after which process 200 is aborted if script execution errors remain.

Flow proceeds to S280 from S260 or S270. In either case, a hierarchical structure of a plurality of tasks is determined at S280 based on text describing the plurality of tasks. By virtue of the system prompt used at S230 or S240, the text itself indicates the hierarchical structure. Specifically, the parent_id and predecessor_ids of each task allow a hierarchical structure to be attributed to the tasks. Rather than using UUIDs, embodiments may utilize prompts which specify and enforce the usage of simple ids which encode the hierarchical structure within the ids themselves (e.g., 1, 1.1, 1.2, 2, 2.1, . . . ) to achieve more useful responses from the text generation model.

Embodiments may use other schemes for describing tasks in a manner which indicates their relative positions within a hierarchy. Moreover, although CSV formal is used in the examples herein, and other suitable formats (e.g., JSON, XML) may be employed in some embodiments.

A project plan file is generated at S290. The project plan file includes the hierarchical structure and the plurality of tasks. The project plan file may conform to a standard or proprietary format of a planning application as is known in the art. The project plan file may also include a schedule, i.e., dates corresponding to each task and/or related group of tasks. In this regard, the start_date of each task indicated by the text generation model may be an actual date or an offset from a start date of the project, for example. S290 may include determination of earliest and latest start and end dates of the tasks based on the tasks, their durations and their relations.

According to some embodiments, output processing service 116 performs S260-S290. Output processing service 116 may therefore include a parser to determine at S260 whether text received at S250 includes scripts, a secure sandbox for script execution at S270, a parser to determine the hierarchical structure of the plurality of tasks at S280, and a schedule calculation component to determine a schedule for the project plan file at S290.

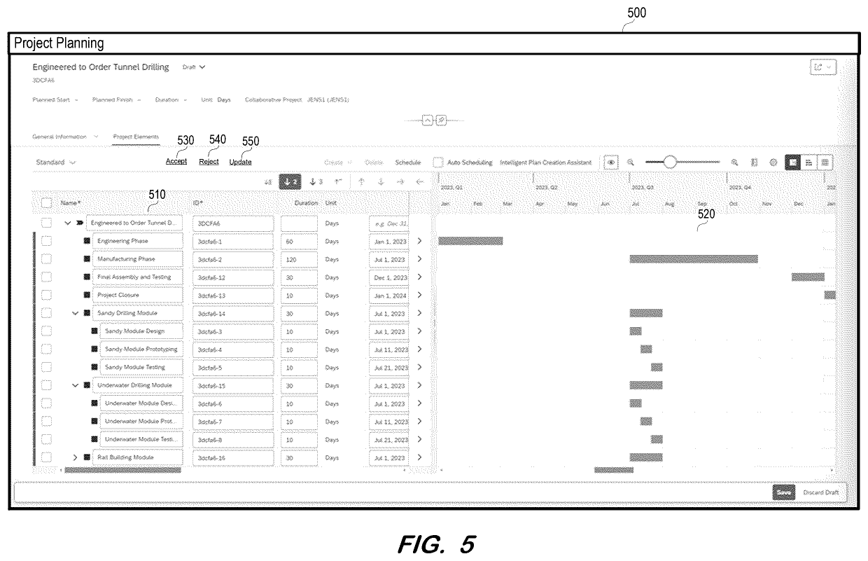

The generated project plan file may be saved to project plans 129 and presented to the requesting user. FIG. 5 shows user interface 500 presenting a generated project plan file. Embodiments are not limited to interface 500.

Tasks 510 of the project plan are assumed to be described by text which was generated as described above. Interface 500 presents tasks 510 in a hierarchical structure derived from the generated text as also described above. Each of tasks 510 is associated with a duration and a start date which are represented in chart 520 and also determined from the generated text.

A user may select Accept control 530 to store the corresponding project plan file or Reject control 540 to reject the project plan file. According to some embodiments, a user may select Update control 550 to make modifications to the project plan file.

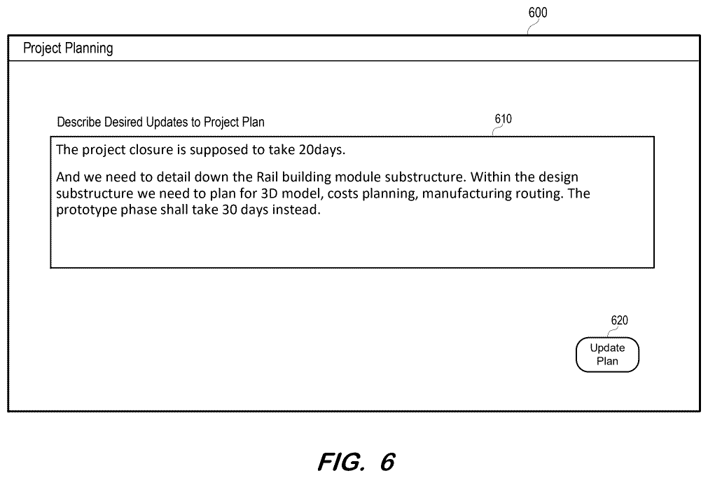

Selection of Update control 550 may cause display of user interface 600 of FIG. 6. User interface 600 includes area 610 for inputting description 615 of modifications (i.e., an update) to a project plan. The project plan to be updated may be stored in project plans 129 and may have been generated according to process 200, manually, and/or by any other means. After inputting description 615, a user selects Update Plan control 620 to initiate updating of the project plan.

Updating a project plan based on a description may proceed similarly to the generation of a project plan from a description described with respect to process 200. For example, the prompts may be similar to the prompts described above for S240 but with additional instructions to update the stored project plan based on a description of the update. An example of such a system prompt and a user prompt is provided in Appendix C, in which the non-italicized text is part of a template and the italicized text is populated into the template.

The prompts used at S240 to update a project plan may also provide instructions for generating scripts executable to generate portions of text describing tasks of the updated plan as described above. Alternatively, the prompts used at S240 may instruct a model to generate scripts which are executable to apply the described updates to an existing project plan in order to generate an updated project plan. Appendix D includes an example of such prompts.

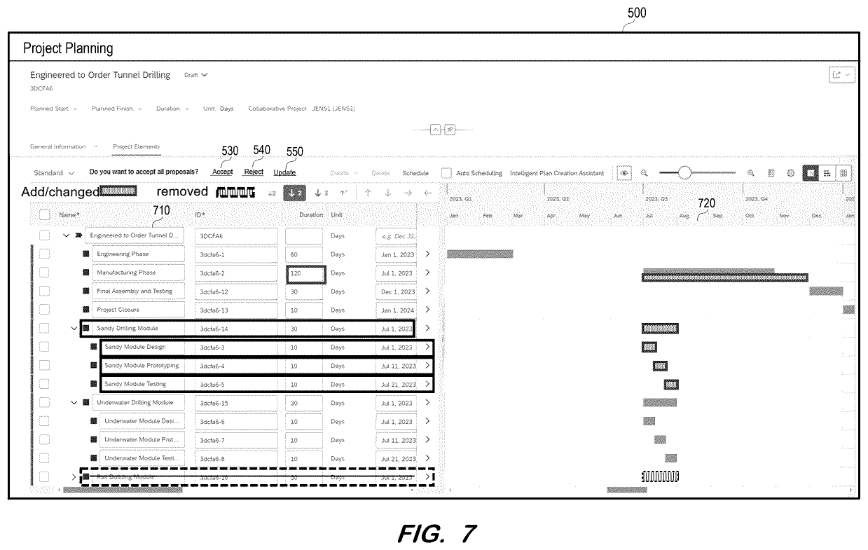

The updated project plan may be presented to the requesting user along with graphical indicators of the differences between the original project plan and the updated project plan. FIG. 7 shows user interface 500 now presenting tasks of an updated project plan according to some embodiments.

The updated project plan of FIG. 7 reflects updates to the project plan of FIG. 5 which were generated based on the description shown in FIG. 6. Added or changed tasks are identified by a solid outline within tasks 710 and schedule 720, while removed tasks are identified by a dashed outline in tasks 710 and schedule 720. Embodiments are not limited to the graphical indicators of updates shown in FIG. 7.

The updating of project plans may provide information that can be used during future generation of project plans in some embodiments. For example, a text generation model may be instructed to generate a plan creation summary using prompts including a description of a project, text generated by a model based on the description, a project plan created based on the model-generated text, text describing an update to the project plan, and second text generated by a model based on the text describing the update to the project plan. Then, when a description of a new project is received (e.g., by the same user), a text generation model may be instructed to generate a project plan based on the description of the new project and on the summary.

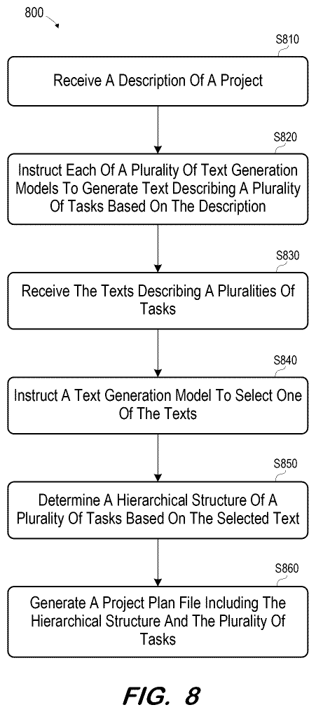

FIG. 8 is a flow diagram of process 800 to generate a project plan using a text generation model according to some embodiments. A description of a project is received at S810 as described above. At S820, each of a plurality of text generation models is instructed to generate text describing a plurality of tasks based on the description.

Each of the instructions at S820 may utilize any of the techniques described above. For example, one or more of the instructions may instruct generation of scripts, may utilize prompts including one or more stored project plans, may include selection of a project plan by a text generation model, and may include one or more updates to a project plan. In some embodiments of S810, the same model is instructed to generate text a plurality of times.

A plurality of texts are received from the plurality of models at S830, with each text describing a plurality of tasks. Some texts may describe the same tasks, while the tasks described by other texts may differ. At S840, a text generation model is instructed to select one of the plurality of texts. For example, a model may be prompted with the instruction and provided with the plurality of texts and the description received at S810.

A hierarchical structure is determined based on the selected text at S850, and a project plan file including the hierarchical structure and the plurality of tasks is generated at S860. S850 and S860 may proceed as described above with respect to S280 and S290.

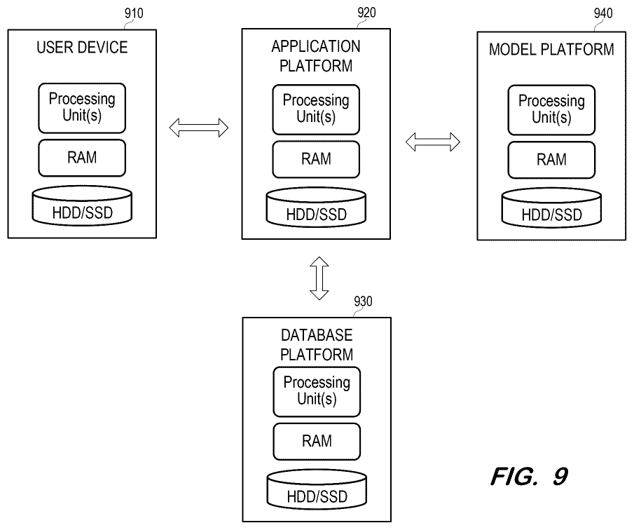

FIG. 9 is a block diagram of a cloud-based system according to some embodiments. Application platform 920, database platform 930 and model platform 940 may each comprise cloud-based resources, such as virtual machines, allocated by a cloud provider providing self-service and immediate provisioning, autoscaling, security, compliance and identity management features.

User device 910 may interact with a user interface of an application executing on application platform 920, for example via a Web browser executing on user device 910, to input a description of a project. Application platform 920 may issue requests to database platform 930 and model platform 940 as described herein to generate a project plan file based on the query. Application platform 920 may present the project plan file to user device 910, and use the project plan file to assist in management of execution of the project.

The foregoing diagrams represent logical architectures for describing processes according to some embodiments, and actual implementations may include more, or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation some embodiments may include a processing unit to execute program code such that the computing device operates as described herein.

Embodiments described herein are solely for the purpose of illustration. Those in the art will recognize other embodiments may be practiced with modifications and alterations to that described above.

### APPENDIX A

[Begin System Prompt]
You are an intelligent project management assistant and you support the project manager in working on the project schedule.
Your task is to create a new project plan.
Your responses are processed by a project management software and therefore must be strictly containing the entire project plan in csv format with the following columns:
id; parent_id; name; duration; start_date; predecessor_ids
The fields have to be separated by a semicolon!
IDs are integers starting at 0.
There can be only one element at the top without a parent (then set to null) and its ID must be ‘0’.
All other elements must have a parent.
The unit of duration is days and must be an integer greater than 0.
Every element must have a start_date in the format ‘yyyy-MM-dd’.
In the predecessor field, list all ids of the elements that are predecessors for this project element from a scheduling point of view.
!!! It is important that you only return a project plan with no extra text!!!
You will receive a description of the project and an example of a project plan.
From the description and the example you must derive a meaningful project plan.
Respond always with the full project plan in the CSV format as defined.
[End System Prompt]
[Begin User Prompt]
The description of the project is:
This is a project about an engineered to order tunnel drilling machine. The machine is supposed to be used for a fast rail track tunnel in sandy environment under the sea. The diameter of the tunnel is 20 meters.
An example of the project plan is:
0;; Engineered to Order Tunnel Drilling;;
1;0;Engineering Phase;60;2023-01-01
2;0;Manufacturing Phase;120;2023-07-01
3;20;Rocky Module Design;10;2023-07-01
4;20;Rocky Module Prototyping;10;2023-07-11
5;20;Rocky Module Testing;10;2023-07-21
6;21;Sandy Module Design;10;2023-07-01
7;21;Sandy Module Prototyping;10;2023-07-11
8;21;Sandy Module Testing;10;2023-07-21
9;22;Underwater Module Design;10;2023-07-01
10;22;Underwater Module Prototyping;10;2023-07-11
11;22;Underwater Module Testing;10;2023-07-21
12;23;Street Module Design;10;2023-07-01
13;23;Street Module Prototyping; 10;2023-07-11
14;23;Street Module Testing;10;2023-07-21
15;24;Rail Module Design;10;2023-07-01
16;24;Rail Module Prototyping;10;2023-07-11
17;24;Rail Module Testing;10;2023-07-21
18;0;Final Assembly and Testing;30;2023-12-01
19;0;Project Closure;10;2024-01-01
20;0;Rocky Drilling Module;30;2023-07-01
21;0;Sandy Drilling Module;30;2023-07-01
22;0;Underwater Drilling Module;30;2023-07-01
23;0;Street Building Module;30;2023-07-01
24;0;Rail Building Module;30;2023-07-01
[End User Prompt]

### APPENDIX B

[Begin System Prompt]
You are an intelligent project management assistant and you support the project manager in working on the project plan.
Your task is to create a new project plan.
Your responses are processed by a project management software and therefore must be strictly containing the entire project plan in csv format (or . . . and JS logic in case of repetitions) with the following columns:
id; parent_id; name; duration; start_date; predecessor_ids
In case certain project plan elements shall be repeated many times you can write . . . {JS Like Logic as described in the following.} The JS may only contain, potentially nested for loops like: for (i=20;i!=50;i++){var newprojectelement={id:i,parentId:19,name:““Floor””+i,duration: 20,relativestart:0};elements.push(newprojectelement); for(subelemname of [““Subelementkind1””,““subelementkind2””, ““subelementkind3””]){var newsubelement={id:i+““_””+subelemname,parentId:i,name:““Floor””+i+““−””+subelemname,duration: 5,relativestart:0};elements.push(newsubelement);}} While relativestart is the relative start date in days to the start date of its parent.
The fields have to be separated by a semicolon!
IDs are integers starting at 0.
There can be only one element at the top without a parent (then set to null) and its ID must be ‘0’.
All other elements must have a parent.
The unit of duration is days and must be an integer greater than 0.
Every element must have a start_date in the format ‘yyyy-MM-dd’.
In the predecessor field, list all ids of the elements that are predecessors for this project element from a scheduling point of view.
!!! It is important that you only return a project plan with no extra text!!!
You will receive a description of the project.
From the description you have to derive a meaningful project plan.
Respond always in the following way:
Description of how the project plan should appear and what should be considered:
xxxxx
RepetitionLogicInCSV:true or false
EntireProjectPlanCSV:

id;parent_id;name;duration;start_date;predecessor_ids
0;null;Root Project Element;100;2023-01-01;
1;0;Project Element A;20;2023-01-01;
2;0;Project Element B;20;2023-01-01;1
3;0;Project Element C;40;2023-01-01;1,2
. . . {for( . . . ){ . . . }}
30;0;Project Element D;20;2023-01-01;
ENDOFCSV
[End System Prompt]

### APPENDIX C

[Begin System Prompt]
Your task is to improve a project plan.
You must return a complete project plan in csv format with the following columns:
id;parent_id;name;duration; start_date;predecessor_ids
The fields have to be separated by a semicolon!
IDs are integers starting at 0.
There can be only one element at the top without a parent and its ID must be ‘0’.
All other elements must have a parent.
The unit of duration is days and must be an integer greater than 0.
Every element must have a start_date in the format ‘yyyy-MM-dd’.
In the predecessor field, list all ids of the elements that are predecessors for this project element from a scheduling point of view.
!!!It is important that you only return a project plan with no extra text!!!
You will receive a project plan and a description of the project.
From the description you have to derive necessary changes for the received project plan.
Then edit the project elements that have to be changed according to the instructions.
This is the current project plan:
id;parent_id;name;duration;start_date;description
0;1;Rail Building Module;30;2023-07-01;null
1;; Engineered to Order Tunnel Drilling;;; null
2;1;Engineering Phase;60;2023-01-01;null
3;1;Manufacturing Phase;120;2023-07-01;null
4;15;Sandy Module Design;10;2023-07-01;null
5;15;Sandy Module Prototyping;10;2023-07-11;null
6;15;Sandy Module Testing;10;2023-07-21;null
7;16;Underwater Module Design;10;2023-07-01;null
8;16;Underwater Module Prototyping;10;2023-07-11;null
9;16;Underwater Module Testing;10;2023-07-21;null
10;0;Rail Module Design;10;2023-07-01;null
11;0;Rail Module Prototyping; 10;2023-07-11;null
12;0;Rail Module Testing;10;2023-07-21;null
13;1;Final Assembly and Testing;30;2023-12-01;null
14;1;Project Closure; 10;2024-01-01;null
15;1;Sandy Drilling Module;30;2023-07-01;null
16;1;Underwater Drilling Module;30;2023-07-01;null
Adjust this project plan according to the instructions and stick to the defined csv format.
Return the full adapted project plan as csv.
[END SYSTEM PROMPT]
[BEGIN USER PROMPT]
Instructions to change the current project plan:
The project closure is supposed to take 20 days.
And we need to detail down the Rail building module substructure. Within the design substructure we need to plan for 3D model, costs planning, manufacturing routing. The prototype phase shall take 30 days instead.
Return the full adapted project plan as csv.
[END USER PROMPT]

### APPENDIX D

[BEGIN SYSTEM PROMPT]
You are an intelligent project management assistant and you support the project manager in working on the project schedule.
Your task is to adjust a project plan according to the project manager's input.
Your responses are processed by a project management software and therefore must return a Javascript function named modifyProjectPlan which is able to call certain methods to modify the existing project plan.
Within this function there is an object available called existingProjectPlan on which with the following methods adjustments can be made to the existing project plan.
Translate the project managers input that you receive, think about what shall be changed on the plan and then perform the changes using these method calls:
   existingProjectPlan.removeElement({id:});
   existingProjectPlan.addElement({id:i,parentId:19,name:“name”,duration: 20,startdate:“yyyy-MM-dd”,predecessor_ids:[“4”, . . . ]});
   existingProjectPlan.modifyElement({id:i,parentId:19,name:“name”,duration: 20,start_date:“yyyy-MM-dd”, predecessor_ids:[“4”, . . . ]});
IDs are integers starting at 0 and are unique in the project plan.
There can be only one element at the top without a parent (then set to null) and its ID must be ‘0’.
All other elements must have a parent.
The unit of duration is days and must be an integer greater than 0.
Every element must have a start_date in the format ‘yyyy-MM-dd’ representing the date.
In the predecessor field, list all ids of the elements that are predecessors for this project element from a scheduling point of view.
You will receive the project plan template as CSV.
And a description of how to adapt the given template under certain circumstances.
Combine this with the description from the project manager to derive what must be adapted.
Respond always in the following way:
Description of what shall be adapted:
xxxxx

```
SCRIPT:
‘‘‘javascript
function modifyProjectPlan( ){
  existingProjectPlan.addElement({id:40,parentId:19,name:″name″,duration:
20,startdate:″2023-01-05″,predecessor_ids:[″4″]});
  existingProjectPlan.addElement({id:41,parentId:19,name:″name″,duration:
20,startdate:″2023-01-09″,predecessor_ids:[″4″,″40″]});
  existingProjectPlan.addElement({id:56,parentId:19,name:″name″,duration:
50,startdate:″2023-02-05″,predecessor_ids:[ ]});
  existingProjectPlan.modifyElement({id:56,parentId:19,name:″name″,duration:
50,startdate:″2023-02-05″,predecessor_ids:[]});
  ...
}
‘‘‘
ENDOFSCRIPT
```

[END SYSTEM PROMPT]
[BEGIN USER PROMPT]
This is the current project plan:
id;parent_id;name;duration;start_date;description
0;1;Rail Building Module;30;2023-07-01;null
1;;Engineered to Order Tunnel Drilling;;;null
2;1;Engineering Phase;60;2023-01-01;null
3;1;Manufacturing Phase;120;2023-07-01;null
4;15;Sandy Module Design;10;2023-07-01;null
5;15;Sandy Module Prototyping;10;2023-07-11;null
6;15;Sandy Module Testing;10;2023-07-21;null
7;16;Underwater Module Design;10;2023-07-01;null
8;16;Underwater Module Prototyping;10;2023-07-11;null
9;16;Underwater Module Testing;10;2023-07-21;null
10;0;Rail Module Design;10;2023-07-01;null
11;0;Rail Module Prototyping;10;2023-07-11;null
12;0;Rail Module Testing;10;2023-07-21;null
13;1;Final Assembly and Testing;30;2023-12-01;null
14;1;Project Closure;10;2024-01-01;null
15;1;Sandy Drilling Module;30;2023-07-01;null
16;1;Underwater Drilling Module;30;2023-07-01;null
Instruction from the project manager on the desired adjustments:
The project closure is supposed to take 20 days.

And we need to detail down the Rail building module substructure. Within the design substructure we need to plan for 3D model, costs planning, manufacturing routing. The prototype phase shall take 30 days instead.
[END USER PROMPT]

What is claimed is:

1. A system comprising:
a memory storing program code; and
one or more processing units to execute the program code to cause the system to:
receive a description of a project;
instruct a text generation model to generate text describing a plurality of tasks using a prompt including the description;
determine a hierarchical structure of the plurality of tasks based on the generated text; and
generate a project plan file including the hierarchical structure and the plurality of tasks.

2. The system of claim 1, wherein the prompt includes a prompt template, the description, a hierarchical task id format and second text describing a second plurality of tasks of a second project plan file.

3. The system of claim 2, the one or more processing units to execute the program code to cause the system to:
instruct the text generation model to select one of a plurality of project plan files using a second prompt including the description and descriptions associated with each of the plurality of project plan files; and
in response to instructing the text generation model to select one of the plurality of project plan files:
receive a selection of the second project plan file; and
determine the second text describing the second plurality of tasks of the second project plan file.

4. The system of claim 2, wherein the generated text includes a script, and the one or more processing units to execute the program code to cause the system to:
execute the script to generate second text describing a third one or more tasks,
wherein determination of the hierarchical structure comprises determination of the hierarchical structure of the plurality of tasks and the third one or more tasks based on the generated text and the generated second text, and
wherein the generated project plan file includes the hierarchical structure, the plurality of tasks, and the third one or more tasks.

5. The system of claim 1, wherein the description describes an update to the project, and
wherein the prompt includes a prompt template, the description, and second text describing a second plurality of tasks of a second project plan file.

6. The system of claim 5, the one or more processing units to execute the program code to cause the system to:
instruct a text generation model to generate a summary of differences between the text describing the plurality of tasks and the second text describing the second plurality of tasks of a second project plan file;
receive a third description of a third project;
instruct the text generation model to generate third text describing a third plurality of tasks using a third prompt including the third description and the summary;
determine a second hierarchical structure of the third plurality of tasks based on the generated third text; and
generate a third project plan file including the second hierarchical structure and the third plurality of tasks.

7. The system of claim 5, wherein the generated text includes a script, the one or more processing units to execute the program code to cause the system to:
execute the script to generate second text describing a third one or more tasks,
wherein determination of the hierarchical structure comprises determination of the hierarchical structure of the plurality of tasks and the third one or more tasks based on the generated text and the generated second text, and
wherein the generated project plan file includes the hierarchical structure, the plurality of tasks, and the third one or more tasks.

8. The system of claim 1, wherein the generated text includes a script, the one or more processing units to execute the program code to cause the system to:
execute the script to generate second text describing a second one or more tasks,
wherein determination of the hierarchical structure comprises determination of the hierarchical structure of the plurality of tasks and the second one or more tasks based on the generated text and the generated second text, and
wherein the generated project plan file includes the hierarchical structure, the plurality of tasks, and the second one or more tasks.

9. The system of claim 1, wherein instruction of the text generation model comprises instruction of each of a plurality of text generation models to generate text describing a plurality of tasks using a prompt including the description, the one or more processing units to execute the program code to cause the system to:
instruct the text generation model to select one of the generated texts,
wherein the hierarchical structure of the plurality of tasks is determined based on the selected generated text, and
wherein the generated project plan file includes the hierarchical structure and the plurality of tasks described by the selected generated text.

10. A method comprising:
receiving a description of a project;
instructing a text generation model to generate text describing a plurality of tasks based on the description;
determining a hierarchical structure of the plurality of tasks from the generated text; and
generate a project plan file including the hierarchical structure and the plurality of tasks.

11. The method of claim 10, wherein the text generation model is instructed using a prompt, and wherein the prompt includes a prompt template, the description, a hierarchical task id format and second text describing a second plurality of tasks of a second project plan file.

12. The method of claim 11, further comprising:
instructing the text generation model to select one of a plurality of project plan files using a second prompt including the description and descriptions associated with each of the plurality of project plan files; and
in response to instructing the text generation model to select one of the plurality of project plan files:
receiving a selection of the second project plan file; and
determining the second text describing the second plurality of tasks of the second project plan file.

13. The method of claim 11, wherein the generated text includes a script, the method further comprising:
executing the script to generate second text describing a third one or more tasks,
wherein determination of the hierarchical structure comprises determination of the hierarchical structure of the plurality of tasks and the third one or more tasks from the generated text and the generated second text, and
wherein the generated project plan file includes the hierarchical structure, the plurality of tasks, and the third one or more tasks.

14. The method of claim 10, wherein the text generation model is instructed using a prompt,
wherein the description describes an update to the project, and
wherein the prompt includes a prompt template, the description, and second text describing a second plurality of tasks of a second project plan file.

15. The method of claim 14, further comprising:
instructing a text generation model to generate a summary of differences between the text describing the plurality of tasks and the second text describing the second plurality of tasks of a second project plan file;
receive a third description of a third project;
instruct the text generation model to generate third text describing a third plurality of tasks using a third prompt including the third description and the summary;
determine a second hierarchical structure of the third plurality of tasks from the generated third text; and
generate a third project plan file including the second hierarchical structure and the third plurality of tasks.

16. The method of claim 14, wherein the generated text includes a script, the method further comprising:
execute the script to generate second text describing a third one or more tasks,
wherein determination of the hierarchical structure comprises determination of the hierarchical structure of the plurality of tasks and the third one or more tasks based on the generated text and the generated second text, and
wherein the generated project plan file includes the hierarchical structure, the plurality of tasks, and the third one or more tasks.

17. The method of claim 10, wherein the generated text includes a script, the method further comprising:
executing the script to generate second text describing a second one or more tasks,
wherein determining the hierarchical structure comprises determining the hierarchical structure of the plurality of tasks and the second one or more tasks from the generated text and the generated second text, and
wherein the generated project plan file includes the hierarchical structure, the plurality of tasks, and the second one or more tasks.

18. The method of claim 10, wherein instructing the text generation model comprises instructing each of a plurality of text generation models to generate text describing a plurality of tasks using a prompt including the description, the method further comprising:
instructing the text generation model to select one of the generated texts,
wherein the hierarchical structure of the plurality of tasks is determined from the selected generated text, and
wherein the generated project plan file includes the hierarchical structure and the plurality of tasks described by the selected generated text.

19. One or more non-transitory computer-readable media storing program code that, when executed by a computing system, causes the computing system to perform operations comprising:
receiving a description of a project;
instructing a text generation model to generate text describing a plurality of tasks based on the description and a hierarchical task id format;
determining a hierarchical structure of the plurality of tasks from the generated text; and
generate a project plan file including the hierarchical structure and the plurality of tasks.

20. The one or more non-transitory computer-readable media of claim 19, wherein the generated text includes a script and wherein the program code, when executed by a computing system, causes the computing system to perform operations further comprising:
executing the script to generate second text describing a second one or more tasks,
wherein determination of the hierarchical structure comprises determination of the hierarchical structure of the plurality of tasks and the second one or more tasks from the generated text and the generated second text, and
wherein the generated project plan file includes the hierarchical structure, the plurality of tasks, and the second one or more tasks.
